(19) United States
(12) Patent Application Publication
(10) Pub. No.: US 2007/0208938 A1
(43) Pub. Date: Sep. 6, 2007

(54) Information processing apparatus and printing apparatus

(75) Inventor: Takaaki Hosoda, Tokyo (JP)

Correspondence Address: TAKEUCHI & KUBOTERA, LLP, SUITE 202, 200 DAINGERFIELD ROAD, ALEXANDRIA, VA, 22314, US

(73) Assignee: Oki Data Corporation

(21) Appl. No.: 11/654,571

(22) Filed: Jan. 18, 2007

(30) Foreign Application Priority Data
Feb. 22, 2006 (JP) 2006-045588

(51) Int. Cl. H04L 9/00

(52) U.S. Cl. 713/168; 382/115; 358/1.14; 340/5.1

(57) ABSTRACT

An information processing apparatus includes a receiving unit for receiving a control command including first identification information; an identification information obtaining unit for obtaining the first identification information from the control command thus received; a storage unit for storing second identification information related to a specific user; an identification information comparing unit for comparing the first identification information with the second identification information; and a control command processing unit for performing a first process when the first identification information matches to the second identification information and performing a second process when the first identification information does not match to the second identification information.

### BACKGROUND OF THE INVENTION

The present invention relates to an information processing apparatus and a printing apparatus.

A conventional printing apparatus connected to a host device such as a personal computer receives various commands other than print data from the host device and performs processes according to the various commands for setting the printing apparatus or collecting information related to a status of the printing apparatus. For example, Japanese Patent Publication No. 11-42836 has disclosed such a printing apparatus.

In the conventional printing apparatus, when a malicious user sends an inappropriate command or an unintended command is inadvertently sent, the printing apparatus still performs a process according to the command thus received. Accordingly, the printing apparatus may be operated improperly, or information stored in the printing apparatus may be easily leaked.

In view of the problems described above, an object of the invention is to provide an information processing apparatus and a printing apparatus, in which it is possible to prevent a malicious operation and information leak.

Further objects of the invention will be apparent from the following description of the invention.

### SUMMARY OF THE INVENTION

In order to attain the objects, according to the present invention, an information processing apparatus comprises a receiving unit for receiving a control command including first identification information; an identification information obtaining unit for obtaining the first identification information from the control command thus received; a storage unit for storing second identification information related to a specific user; an identification information comparing unit for comparing the first identification information with the second identification information; and a control command processing unit for performing a first process when the first identification information matches to the second identification information and performing a second process when the first identification information does not match to the second identification information.

### BRIEF DESCRIPTION OF THE DRAWINGS

FIG. 1 is a block diagram showing a configuration of a printer according to a first embodiment of the present invention;

FIG. 2 is a schematic view showing a configuration of a control command according to the first embodiment of the present invention;

FIG. 3 is a schematic view showing an example of a header of the control command according to the first embodiment of the present invention;

FIG. 4 is a schematic view showing an example of identification information of the control command according to the first embodiment of the present invention;

FIG. 5 is a schematic view showing an example of command contents of the control command according to the first embodiment of the present invention;

FIG. 6 is a schematic view showing an example of identification information stored in a storage unit according to the first embodiment of the present invention;

FIG. 7 is a flow chart of an operation of registering user information according to the first embodiment of the present invention;

FIG. 8 is a flow chart of an operation upon receiving the control command according to the first embodiment of the present invention;

FIG. 9 is a flow chart of a sub-routine of an execution process of the control command according to the first embodiment of the present invention;

FIG. 10 is a block diagram showing a configuration of a printer according to a second embodiment of the present invention;

FIG. 11 is a schematic view showing a configuration of a control command according to the second embodiment of the present invention;

FIG. 12 is a flow chart of an operation upon receiving the control command according to the second embodiment of the present invention;

FIG. 13 is a block diagram showing a configuration of a printer according to a third embodiment of the present invention;

FIG. 14 is a block diagram showing a configuration of an authentication server according to the third embodiment of the present invention;

FIG. 15 is a flow chart of an operation upon receiving the control command according to the third embodiment of the present invention;

FIG. 16 is a flow chart of an operation of the authentication server according to the third embodiment of the present invention;

FIG. 17 is a block diagram showing a configuration of a printer according to a fourth embodiment of the present invention;

FIG. 18 is a block diagram showing a configuration of an administrator host according to the fourth embodiment of the present invention;

FIG. 19 is a schematic view showing an example of information stored in an information collecting and storage unit according to the fourth embodiment of the present invention;

FIG. 20 is a schematic view showing an example of information stored in a destination storage unit according to the fourth embodiment of the present invention;

FIG. 21 is a schematic view showing an example of notification contents according to the fourth embodiment of the present invention;

FIG. 22 is a flow chart of an operation of collecting information according to the fourth embodiment of the present invention;

FIG. 23 is a flow chart of an operation of notifying information to the notification destination according to the fourth embodiment of the present invention; and

FIG. 24 is a flow chart of an operation of the administrator host according to the fourth embodiment of the present invention.

### DETAILED DESCRIPTION OF THE PREFERRED EMBODIMENTS

Hereunder, embodiments of the present invention will be described in more detail with reference to the accompanying drawings.

### First Embodiment

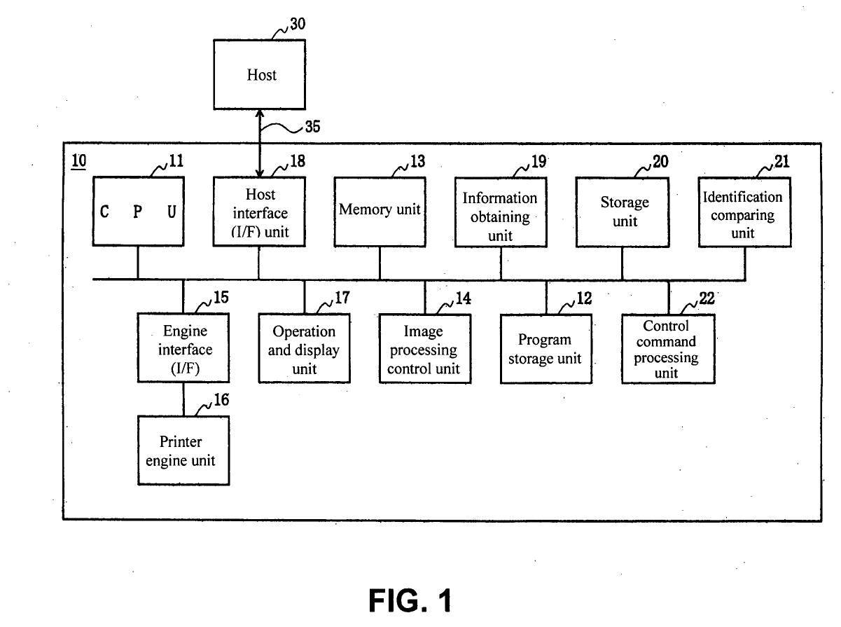

FIG. 1 is a block diagram showing a configuration of a printer 10, i.e., a printing apparatus as an information processing apparatus, according to a first embodiment of the present invention. The printer 10 may include an ink-jet printer, an electro-photography printer, a copier, a facsimile device, an image reading, a multi-function device having functions of a printer, a copier, a facsimile, and any other devices. Further, the printer 10 may be a device forming a monochrome image or a color image. In the embodiment, the printer 10 is an electro-photography printer.

As shown in FIG. 1, the printer 10 includes a CPU 11 for controlling the apparatus as a whole; a program storage unit 12; a memory unit 13; an image processing control unit 14; an engine interface (I/F) 15; a printer engine unit 16; an operation and display unit 17; a host interface (I/F) unit 18 as a receiving unit; an information obtaining unit 19 as an identification information obtaining unit; a storage unit 20; an identification comparing unit 21 as an identification information comparing unit; and a control command processing unit 22. The printer 10 is connected to a host 30 as an upper device through an interface cable 35 as a communication line.

The CPU 11 is formed of a microprocessor and the likes. Through execution of a program (firmware) stored in the program storage unit 12, the CPU 11 controls operations of the printer 10 as a whole including execution of a control command (described later), troubleshooting, information collection, and the likes. The program storage unit 12 is formed of a non-volatile memory such as a ROM, a flash memory, and the likes, and stores the program for controlling the printer 10 as a whole. Note that is it possible to rewrite the program written in the program storage unit 12.

The memory unit 13 is formed of a RAM, a flash memory, a hard disk, and the likes. The memory unit 13 temporarily stores information and the likes necessary for executing the program, and stores various information, information collection results, print data, and the likes. The image processing control unit 14 performs a process of image information that the printer 10 receives from the host 30, for example, a process such as compression, extension, code conversion, encryption, decryption, and the likes.

The operation and display unit 17 performs input of information to the printer 10 and displays information representing an operational state of the printer 10. The operation and display unit 17 is formed of a keyboard, a push button, a touch button, and the likes. A display unit of the operation and display unit 17 is formed of a liquid crystal display, an LED (Light Emitting Diode) display, and the likes.

The host I/F unit 18 performs a connection process relative to the host 30. The host 30 may be connected to the printer 10 through various connection methods including a USB (Universal Serial Bus) connection, a parallel connection, a network connection, and the likes. The information obtaining unit 19 performs a process of retrieving identification information from the control command sent from the host 30.

The storage unit 20 stores user identification information such as a user ID, a password, and the likes. The identification comparing unit 21 compares the identification information or first identification information retrieved from the control command by the information obtaining unit 19 with the user identification information (user information) or second identification information stored in the storage unit 20.

The control command processing unit 22 performs a process of discarding the control command received from the host 30 when the comparison result of the identification comparing unit 21 is not match. The host 30 performs a process of creating the image information and the control command.

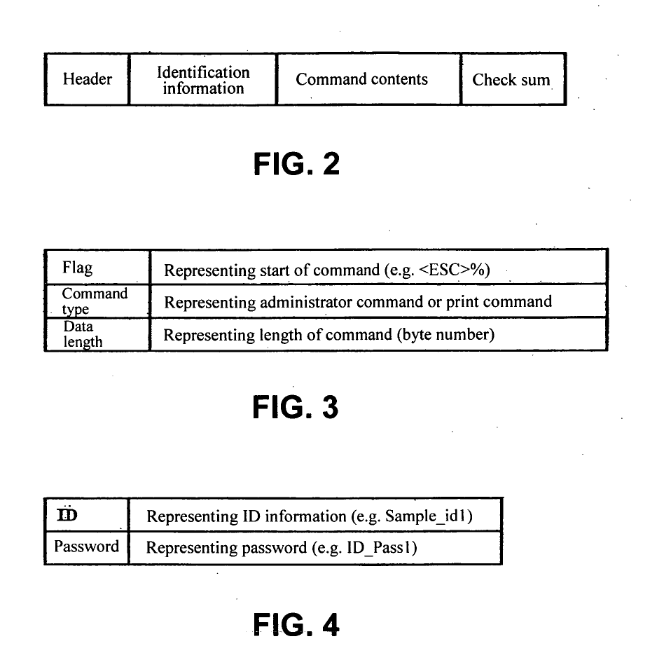

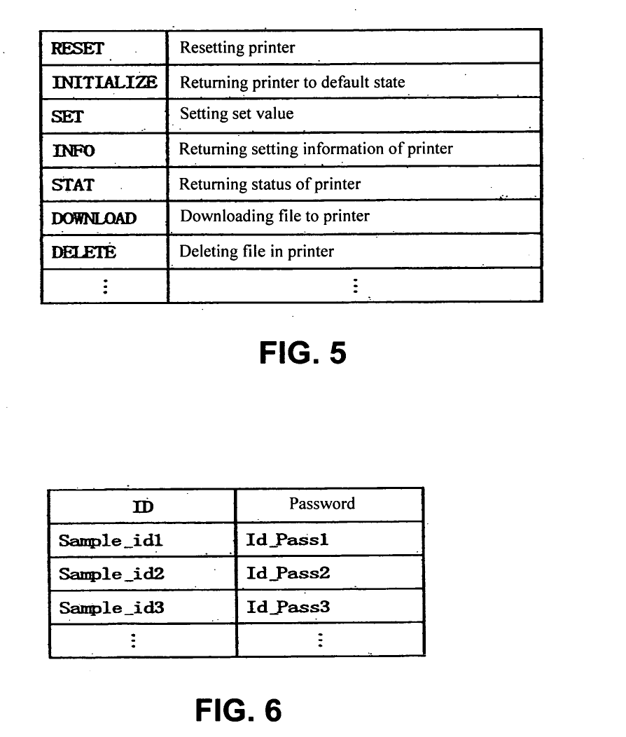

The control command will be explained next. FIG. 2 is a schematic view showing a configuration of the control command according to the first embodiment of the present invention. FIG. 3 is a schematic view showing an example of a header of the control command according to the first embodiment of the present invention. FIG. 4 is a schematic view showing an example of the identification information of the control command according to the first embodiment of the present invention. FIG. 5 is a schematic view showing an example of command contents of the control command according to the first embodiment of the present invention.

As shown in FIG. 2, the control command includes the header shown in FIG. 3 for identifying contents of data; the identification information shown in FIG. 4 for identifying a user; and the command contents shown in FIG. 5 and a check sum for determining whether data communication is conducted normally.

In the command contents shown in FIG. 5, SET is for setting a set value. The set value of the printer 10 includes a set value related to selection of a sheet supply tray; a set value related to a type of medium (a sheet thickness, a size, and the likes) to be stored in the sheet supply tray; a set value related to adjustment of print image quality (resolution, color adjustment); and the likes.

Further, in the command contents shown in FIG. 5, STAT is for returning status information of the printer 10. The status information of the printer 10 includes error information; information related to a used amount of toner; information related to a life of consumable supply; information related to fee; and the likes. DOWNLOAD is for downloading a file to the printer 10. DELETE is for deleting a file in the printer. The file includes a print data file, a setting data file, and the likes.

The identification information or the user information stored in the storage unit 20 will be explained next. FIG. 6 is a schematic view showing an example of the identification information stored in the storage unit 20 according to the first embodiment of the present invention.

As shown in FIG. 6, the storage unit 20 stores the identification information or the user information of a user authorized to use the printer 10. The user information includes an ID, i.e., a unique number assigned to a specific user, and a password set by the user. The ID and the password are stored in the storage unit 20 in a state of corresponding to each user.

An operation of the printer 10 will be explained next. First, the user information of the printer 10, i.e., the ID and the password, is stored in the storage unit 20 as pre-registration. The user information may be registered with a method in which the user information is directly input from the operation and display unit 17 or the user information is sent from the host 30 to the printer 10 as registration data.

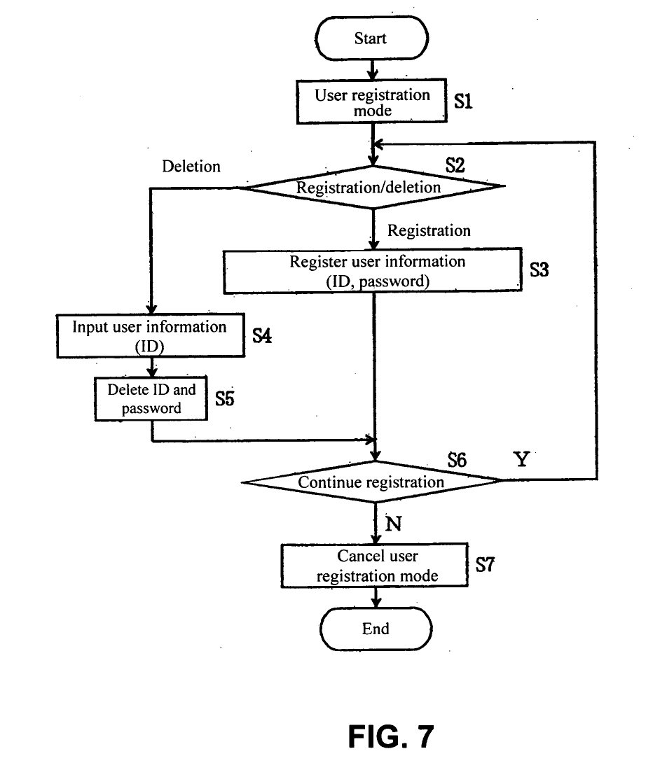

In the embodiment, the user information is directly input through an operation of the operation and display unit 17. FIG. 7 is a flow chart of the operation of registering the user information according to the first embodiment of the present invention.

First, the user operates the operation and display unit 17 to switch the printer 10 to a mode for registering the user information, i.e., a user registration mode. Then, the user operates the operation and display unit 17 to input the ID and the password corresponding to the ID shown in FIG. 6. In the user registration mode, it is possible to select whether the user information is newly registered or the user information already registered is deleted. When the registration is selected, the user can input the user information, i.e., the ID and the password, through the operation and display unit 17.

When the user inputs the user information, i.e., the ID and the password, the CPU 11 stores the ID and the password thus input into the storage unit 20 to register the user information. Then, the CPU 11 controls the operation and display unit 17 to display whether the registration operation is continued, so that the user can select whether the registration operation is continued.

When the user selects that the registration operation is continued, the operation and display unit 17 displays again whether the user information is newly registered or the user information already registered is deleted. When the user selects that the registration operation is not continued, the user registration mode is canceled, thereby completing the registration operation of the user information.

When the user selects that the user information already registered is deleted, the operation and display unit 17 displays a screen prompting the user to input an ID corresponding to the user information to be deleted. When the user operates the operation and display unit 17 to input the ID, the CPU 11 deletes the ID and the password (user information) corresponding to the ID thus input from the storage unit 20. Then, the CPU 11 controls the operation and display unit 17 to display whether the registration operation is continued, so that the user can select whether the registration operation is continued.

The flow chart of the operation of registering the user information will be explained next. In step S1, the printer 10 is switched to the user registration mode. In step S2, the user selects whether the user information is registered or the user information is deleted. When the registration is selected, the process proceeds to step S3. When the deletion is selected, the process proceeds to step S4.

In step S3, the ID and the password are stored in the storage unit 20 to register the user information. In step S4, the user inputs the ID corresponding to the user information to be deleted. In step S5, the ID and the password corresponding to the ID thus input are deleted from the storage unit 20, thereby deleting the user information. In step S6, it is determined whether the registration operation is continued. When the registration (deletion) operation is continued, the process returns to step S2. When the registration (deletion) operation is not continued, the process proceeds to step S7. In step S7, the user registration mode is canceled, thereby completing the process.

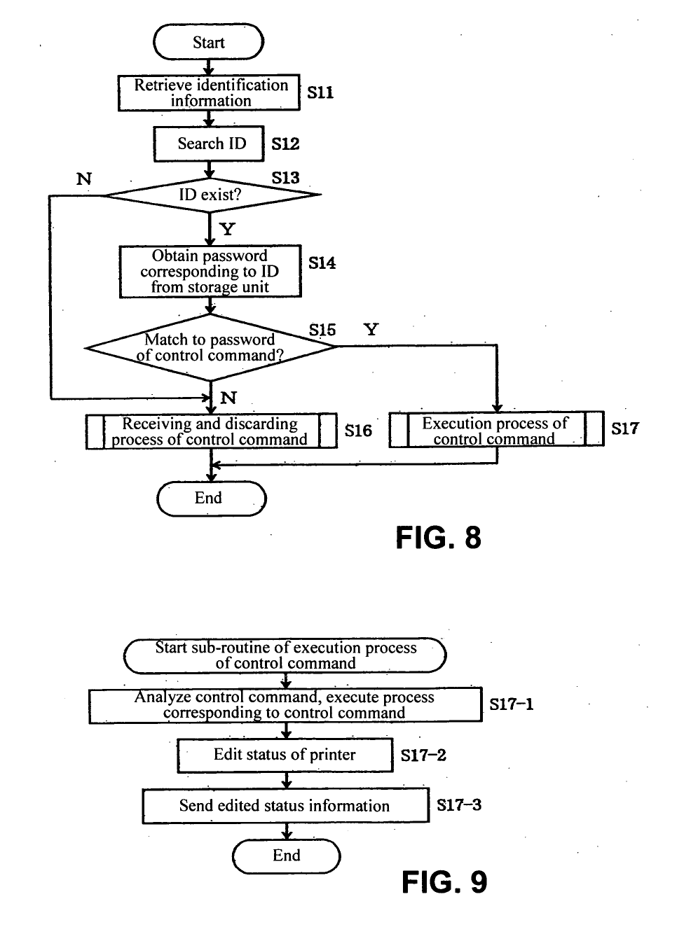

An operation when the printer 10 receives the control command from the host 30 will be explained next. FIG. 8 is a flow chart of the operation upon receiving the control command according to the first embodiment of the present invention.

First, when the control command for controlling the printer 10 shown in FIG. 2 is received, or the control command for receiving the status information from the printer 10 is received, the printer 10 temporarily stores the control command thus received in the memory unit 13. Afterward, the information obtaining unit 19 retrieves the identification information of the control command stored in the memory unit 13. Then, the identification comparing unit 21 determines whether an ID corresponding to an ID of the identification information (first identification information) is registered in the storage unit 20 with an ID of the identification information (second identification information) registered in the storage unit 20 as a search subject.

More specifically, for example, when the ID of the identification information retrieved from the memory unit 13 is Sample_idx, the ID of Sample_idx is sequentially compared with the IDs registered in the storage unit 20 (FIG. 6), i.e., Sample_id1, Sample_id2, and the likes, so that it is determined that an identical ID exists. When an ID corresponding to the ID of the identification information retrieved from the host 30 is registered in the storage unit 20, the identification comparing unit 21 obtains a password corresponding to the ID thus matched from the storage unit 20. The password thus obtained is compared with the password in the control command, so that it is determined whether they are matched.

When they are matched, the control command processing unit 22 determines that the control command thus received is a command (referred to as an authenticated command) from the user who is authorized to use the printer 10, thereby performing an execution process of the control command thus received. When they are not matched, the control command processing unit 22 determines that the control command thus received is a command (referred to as a non-authenticated command) from the user who is not authorized to use the printer 10, thereby performing a receiving and discarding process of the control command thus received.

Note that when the identification comparing unit 21 compares the ID of the identification information (first identification information) retrieved from the control command with the ID of the identification information (second identification information) registered in the storage unit 20, and determines that there no identical ID, the control command processing unit 22 performs the receiving and discarding process of the control command as is.

The flow chart of the operation upon receiving the control command will be explained next. In step S11, the identification information is retrieved from the control command. In step S12, the ID is searched. In step S13, it is determined whether the identical ID exists. When the identical ID exists, the process proceeds to step S14. When the identical ID does not exist, the process proceeds to step S16.

In step S14, the password corresponding to the ID retrieved from the storage unit 20 is obtained. In step S15, it is determined whether the password retrieved from the storage unit 20 matches to the password in the control command. When both passwords are matched, the process proceeds to step S17. When both passwords are not matched, the process proceeds to step S16. In step S16, the receiving and discarding process of the control command is performed, thereby completing the process. In step S17, the execution process of the control command is performed, thereby completing the process.

A sub-routine of the execution process of the control command in step S17 shown in FIG. 8 will be explained next. FIG. 9 is a flow chart of the sub-routine of the execution process of the control command according to the first embodiment of the present invention.

First, the control command processing unit 22 analyzes the control command temporarily stored in the memory unit 13, and executes a process specified in advance and corresponding to the control command. For example, when STAT “return status information of printer” among the control commands shown in FIG. 5 is received, the control command processing unit 22 determines the state (status) of the printer 10 at that time and edits the status into a specific data format, so that the edited status information is sent to the host 30.

The flow chart of the sub-routine of the execution process of the control command will be explained next. In step S17-1, the control command is analyzed, and the process specified in advance and corresponding to the control command is executed. In step S17-2, the status of the printer 10 is edited into the specific data format. In step S17-3, the edited status information is sent to the host 30, thereby completing the process.

The receiving and discarding process of the control command in step S16 shown in FIG. 8 will be explained next. In the receiving and discarding process of the control command, the control command processing unit 22 deletes the control command temporarily stored in the memory unit 13, and performs no process of the control command. Note that, in addition to the receiving and discarding process, it may be configured such that the operation and display unit 17 displays the discard of the control command, or the host 30 is notified through the host interface (I/F) unit 18.

In the embodiment, an example of the method of determining the authenticity of the control command is shown. Note that is it possible to determine the authenticity of the control command according to a method, a configuration, or a flow chart other than those in the embodiment.

As described above, in the embodiment, it is determined whether the control command thus received is the command from the user who is authorized to use the printer 10, i.e., the authenticated command, or the command from the user who is not authorized to use the printer 10, i.e., the non-authenticated command, so that only the authenticated command is processed. Accordingly, it is possible to prevent the operation of the information processing apparatus based on an improper command, thereby preventing leak of information.

### Second Embodiment

A second embodiment will be explained next with reference to the accompanying drawings. Components in the second embodiment having configurations similar to those in the first embodiment are designated with the same reference numerals, and explanations thereof are omitted. Explanation of operations and effects in the second embodiment same as those in the first embodiment are omitted as well.

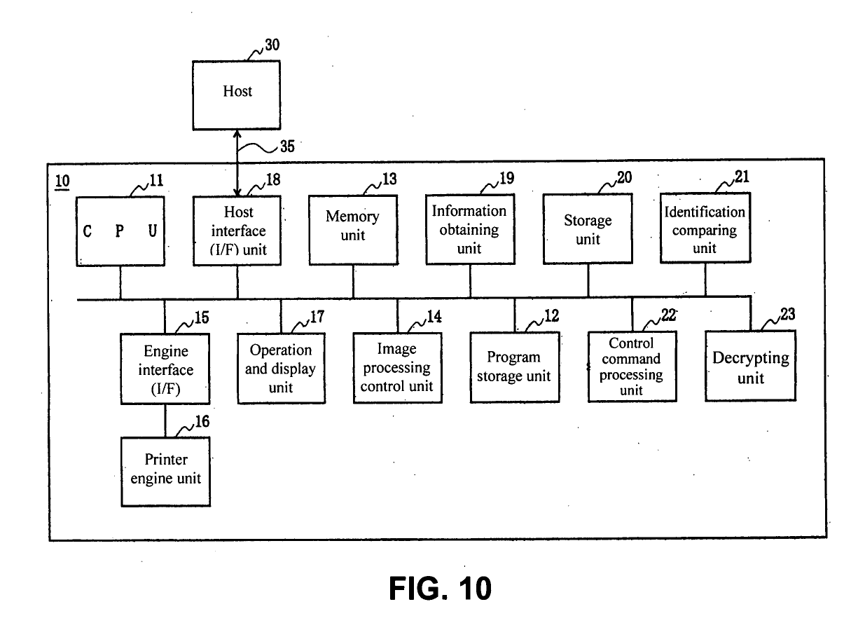

FIG. 10 is a block diagram showing a configuration of a printer 10 according to the second embodiment of the present invention. In the second embodiment, the printer 10 is provided with a decrypting unit 23 for decrypting encrypted identification information. Other configurations in the second embodiment are the same as those in the first embodiment, and explanations thereof are omitted.

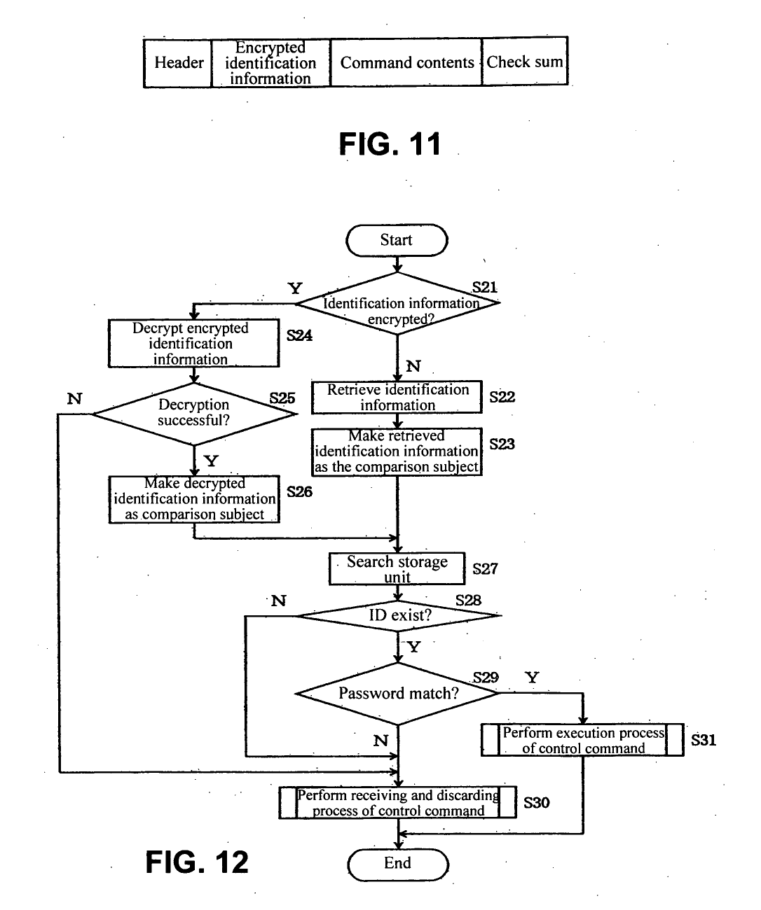

A control command in the second embodiment will be explained next. FIG. 11 is a schematic view showing the configuration of the control command according to the second embodiment of the present invention.

As shown in FIG. 11, the control command includes a header for identifying contents of data; the encrypted identification information for identifying a user; command contents; and a check sum for determining whether data communication is conducted normally. Note that the header includes information related to the encryption of the identification information.

An operation of the printer 10 according to the second embodiment will be explained next. In the operation in the second embodiment, the printer 10 receives the control command from the host 30. FIG. 12 is a flow chart of the operation upon receiving the control command according to the second embodiment of the present invention.

First, when the control command shown in FIG. 11 for controlling the printer 10, or the control command for obtaining the status information from the printer 10 is received, the printer 10 temporarily stores the control command thus received in the memory unit 13. Then, the CPU 11 retrieves the header in the control command from the memory unit 13, and determines whether the identification information is encrypted with reference to information in the header indicating the encryption.

When the CPU 11 determines that the identification information is not encrypted, the information obtaining unit 19 retrieves the identification information of the control command stored in the memory unit 13. At this time, the identification comparing unit 21 treats the identification information retrieved from the memory unit 13 (first identification information) as comparison subject information relative to the identification information of the user registered in the storage unit 20 (second identification information).

When the CPU 11 determines that the identification information is encrypted, the decrypting unit 23 decrypts the encrypted identification information according to a method specified in advance. In the method specified in advance, for example, when the host 30 encrypts the identification information using RC4 algorism, the decrypting unit 23 decrypts the encrypted identification information using the same RC4 algorism. In this case, key information used for the encryption and decryption is registered in the host 30 and the printer 10 in advance.

A key for decrypting the encrypted identification information is determined in advance, and the decrypting unit 23 decrypts the encrypted identification information using the key. Then, the CPU 11 determines whether the decryption of the identification information is successful. When the CPU 11 determines that the decryption of the identification information is successful, the identification comparing unit 21 treats the decrypted information retrieved (first identification information) as comparison subject information relative to the identification information of the user registered in the storage unit 20 (second identification information).

Afterward, the identification comparing unit 21 determines whether an ID matching to the ID of the decrypted identification information is registered in the storage unit 20. An operation after this step is the same as that in the first embodiment, and explanation thereof is omitted.

The flow chart of the operation upon receiving the control command will be explained next. In step S21, it is determined whether the identification information is encrypted. When the identification information is encrypted, the process proceeds to step S24. When the identification information is not encrypted, the process proceeds to step S22.

In step S22, the identification information is retrieved from the control command. In step S23, the identification information thus retrieved is treated as the comparison subject. In step S24, the decrypting unit 23 decrypts the encrypted identification information. In step S25, it is determined whether the decryption of the identification information is successful. When the decryption of the identification information is successful, the process proceeds to step S26. When the decryption of the identification information is not successful, the process proceeds to step S30.

In step S26, the identification information thus decrypted is treated as the comparison subject. In step S27, the storage unit 20 is searched. In step S28, it is determined whether the identical ID exists. When the identical ID exists, the process proceeds to step S29. When the identical ID does not exist, the process proceeds to step S30.

In step S29, the password corresponding to the ID retrieved from the storage unit 20 is obtained, and it is determined whether the password retrieved from the storage unit 20 matches to the password in the control command. When both passwords are matched, the process proceeds to step S31. When both passwords are not matched, the process proceeds to step S30. In step S30, the receiving and discarding process of the control command is performed, thereby completing the process. In step S31, the execution process of the control command is performed, thereby completing the process.

As described above, in the second embodiment, it is determined whether the control command thus received is the command from the user who is authorized to use the printer 10, i.e., the authenticated command, or the command from the user who is not authorized to use the printer 10, i.e., the non-authenticated command, so that only the authenticated command is processed. Accordingly, it is possible to prevent the operation of the information processing apparatus based on an improper command, thereby preventing leak of information. Further, through the encryption of the identification information of the control command, it is possible to prevent leak of the identification information.

### Third Embodiment

A third embodiment will be explained next with reference to the accompanying drawings. Components in the third embodiment having configurations similar to those in the first and second embodiments are designated with the same reference numerals, and explanations thereof are omitted. Explanation of operations and effects in the third embodiment same as those in the first and second embodiments are omitted as well.

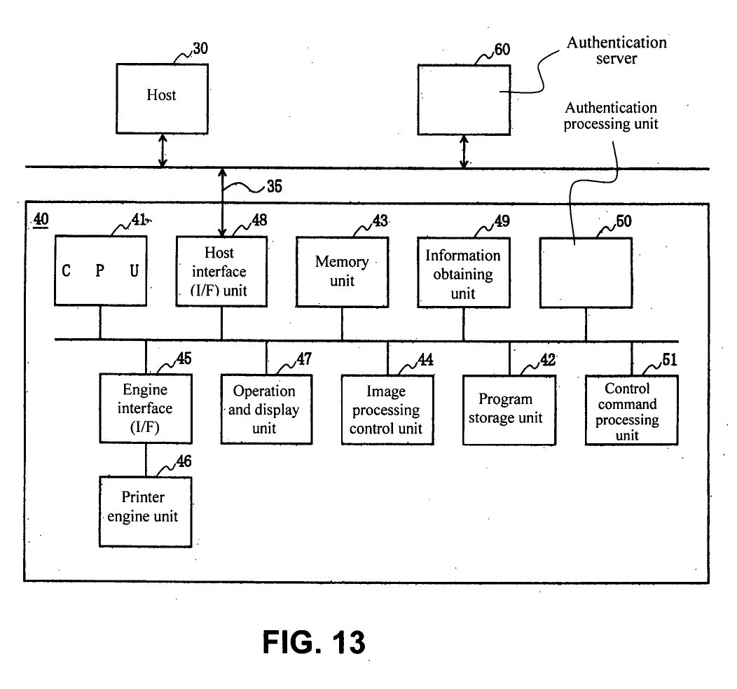

FIG. 13 is a block diagram showing a configuration of a printer 40, i.e., a printing apparatus as an information processing apparatus, according to the third embodiment of the present invention. The printer 40 may include an ink-jet printer, an electro-photography printer, a copier, a facsimile device, an image reading, a multi-function device having functions of a printer, a copier, a facsimile, and any other devices. Further, the printer 40 may be a device forming a monochrome image or a color image. In the embodiment, the printer 40 is an electro-photography printer.

As shown in FIG. 13, the printer 40 includes a CPU 41 for controlling the apparatus as a whole; a program storage unit 42; a memory unit 43; an image processing control unit 44; an engine interface (I/F) 45; a printer engine unit 46; an operation and display unit 47; a host interface (I/F) unit 48 as a receiving unit; an information obtaining unit 49 as an identification information obtaining unit; an authentication processing unit 50; and a control command processing unit 51. The printer 40 is connected to the host 30 as an upper device and an authentication server 60 as an authentication device through the interface cable 35 as a communication line.

The CPU 41 is formed of a microprocessor and the likes. Through execution of a program (firmware) stored in the program storage unit 42, the CPU 41 controls operations of the printer 40 as a whole including execution of the control command, troubleshooting, information collection, and the likes. The program storage unit 42 is formed of a non-volatile memory such as a ROM, a flash memory, and the likes, and stores the program for controlling the printer 40 as a whole. Note that is it possible to rewrite the program written in the program storage unit 42.

The memory unit 43 is formed of a RAM, a flash memory, a hard disk, and the likes. The memory unit 43 temporarily stores information and the likes necessary for executing the program, and stores various information, information collection results, print data, and the likes. The image processing control unit 44 performs a process of image information that the printer 40 receives from the host 30, for example, a process such as compression, extension, code conversion, encryption, decryption, and the likes.

The operation and display unit 47 performs input of information to the printer 40 and displays information representing an operational state of the printer 40. The operation and display unit 47 is formed of a keyboard, a push button, a touch button, and the likes. A display unit of the operation and display unit 47 is formed of a liquid crystal display, an LED display, and the likes.

The host I/F unit 48 performs a connection process relative to the host 30 and the authentication server 60. The host 30 and the authentication server 60 may be connected to the printer 40 through various connection methods including a USB (Universal Serial Bus) connection, a parallel connection, a network connection, and the likes. The information obtaining unit 49 performs a process of retrieving identification information from the control command sent from the host 30.

The authentication processing unit 50 sends identification information or first identification information retrieved from the control command by the information obtaining unit 49 to the authentication server 60. The identification processing unit 50 also receives a comparison result (authentication result) relative to identification information of a user or second identification information registered in the authentication server 60.

The control command processing unit 51 performs a process of discarding the control command received from the host 30 when the authentication processing unit 50 determines that the control command is not authenticated, i.e., the non-authenticated command, according to the authentication result received from the authentication server 60. The authentication server 60 stores identification information of a user who is authorized to use the printer 40. The authentication server 60 also determines whether the control command sent from the host 30 is the control command from the user who is authorized to use the printer 40. The host 30 performs a process of creating the image information and the control command.

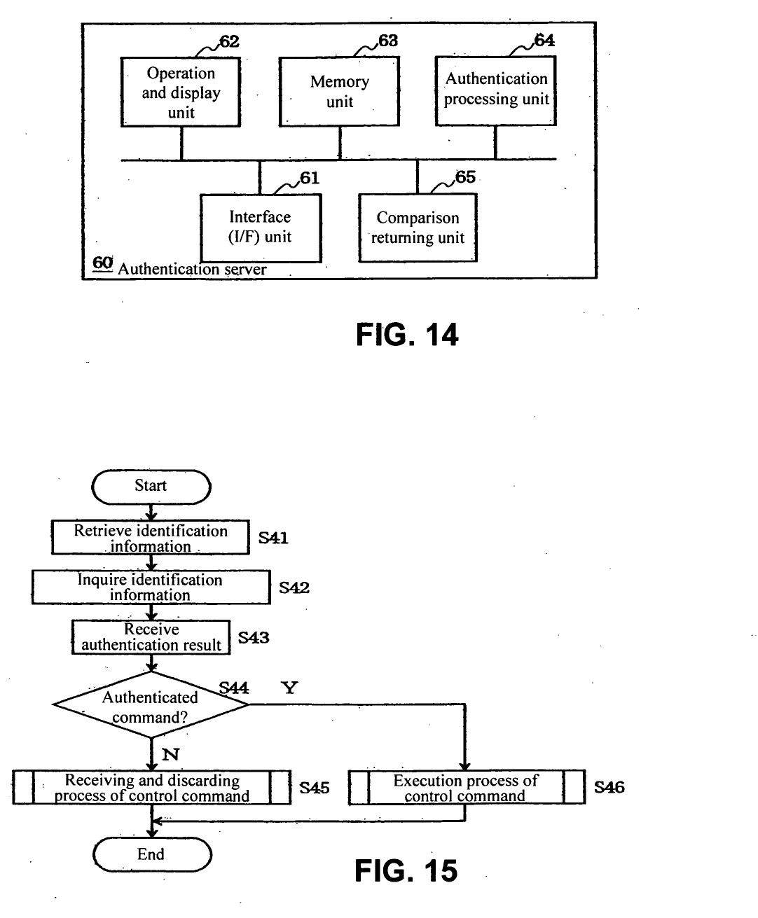

A configuration of the authentication server 60 will be explained next. FIG. 14 is a block diagram showing the configuration of the authentication server 60 according to the third embodiment of the present invention.

As shown in FIG. 14, the authentication server 60 includes an interface (I/F) unit 61 for performing communication with the printer 40 and the likes; an operation and display unit 62 for operating and displaying; a memory unit 63 for storing the identification information of the user to authenticate the identification information sent from the printer 40; an authentication processing unit 64 for performing an authentication process; and a comparison returning unit 65 for returning the authentication result to the printer 40.

An operation of the printer 40 according to the third embodiment will be explained next. First, authentication server information such as an authentication server name and an IP (Internet Protocol) address is stored in the authentication processing unit 50 as pre-registration. The authentication server information may be registered with a method in which the authentication server information is directly input from the operation and display unit 47 or the authentication server information is sent from the host 30 to the printer 40 as authentication server data. In the embodiment, the authentication server information is directly input through an operation of the operation and display unit 47.

First, the user operates the operation and display unit 47 to switch the printer 40 to a mode for registering the authentication server information, i.e., an authentication server registration mode. Then, the user operates the operation and display unit 47 to input the authentication server information. The CPU 41 registers the authentication server information input through the operation and display unit 47 to the authentication processing unit 50. After the authentication server information is registered to the authentication processing unit 50, the authentication server registration mode is canceled, thereby completing the registration process of the authentication server information.

An operation of the printer 40 upon receiving the control command from the host 30 will be explained next. FIG. 15 is a flow chart of the operation upon receiving the control command according to the third embodiment of the present invention

First, when the control command shown in FIG. 2 for controlling the printer 40, or the control command for obtaining the status information from the printer 40 is received, the printer 40 temporarily stores the control command thus received in the memory unit 43. Then, the information obtaining unit 49 retrieves the identification information of the control command stored in the memory unit 43.

At this time, the authentication processing unit 50 sends the identification information retrieved from the memory unit 43 by the information obtaining unit 49 to the authentication server 60 to inquire whether the identification information thus retrieved is sent from the user who is authorized to use the printer 40. The authentication server 60 compares the identification information sent from the printer 40 with the identification information of the user stored in the memory unit 63. The comparison returning unit 65 of the authentication server 60 returns the comparison result at the authentication processing unit 64 as the authentication result to the printer 40.

When the printer 40 receives the authentication result from the authentication server 60, the authentication processing unit 50 determines whether the control command received from the host 30 is the authenticated command according to the authentication result received from the authentication server 60. When the authentication processing unit 50 determines that the control command is the authenticated command, the control command processing unit 51 performs the execution process of the control command. When the authentication processing unit 50 determines that the control command is not authenticated, i.e., the non-authenticated command, the control command processing unit 51 performs the receiving and discarding process of the control command thus received.

When the control command processing unit 51 performs the execution process of the control command, the control command processing unit 51 analyzes the control command temporarily stored in the memory unit 43, and executes a process specified in advance and corresponding to the control command. For example, status information of the printer 40 is sent to the host 30, or a printing process is performed. When the control command processing unit 51 performs the receiving and discarding process of the control command, the control command processing unit 51 deletes the control command temporarily stored in the memory unit 43, and performs no process of the control command.

The flow chart of the operation upon receiving the control command will be explained next. In step S41, the identification information is retrieved from the control command. In step S42, the identification information is inquired to the authentication server 60. In step S43, the authentication result is received from the authentication server 60. In step S44, it is determined whether the control command thus received is the authenticated command. When the control command thus received is the authenticated command, the process proceeds to step S46. When the control command thus received is not the authenticated command, the process proceeds to step S45.

In step S45, the receiving and discarding process of the control command is performed, thereby completing the process. In step S46, the execution process of the control command is performed, thereby completing the process.

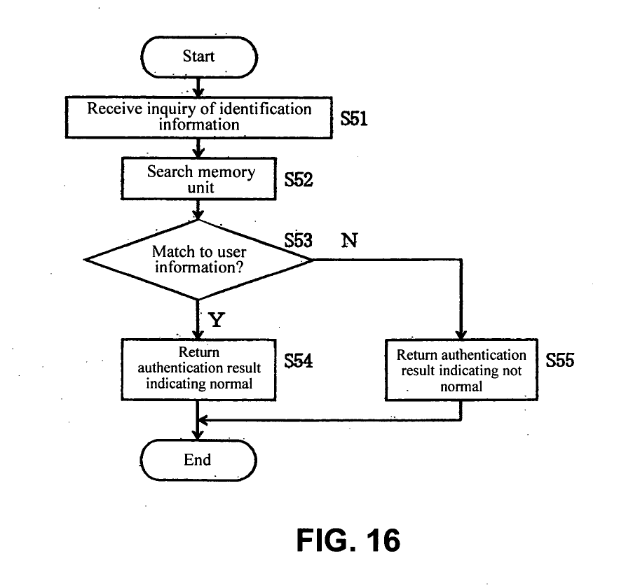

An operation of the authentication server 60 will be explained next. FIG. 16 is a flow chart of the operation of the authentication server 60 according to the third embodiment of the present invention.

First, when the authentication server 60 receives the inquiry of the identification information from the printer 40, the authentication processing unit 64 searches the memory unit 63 to determine whether identification information having an ID and a password matching to the ID and the password of the identification information (first identification information) sent from the printer 40 is registered in the memory unit 63.

When the ID and the password of the identification information sent from the printer 40 match to the ID and the password of the identification information registered in the memory unit 63, the comparison returning unit 65 returns the authentication result indicating that the authentication is normal to the printer 40. When the ID and the password of the identification information sent from the printer 40 do not match to the ID and the password of the identification information registered in the memory unit 63, the comparison returning unit 65 returns the authentication result indicating that the authentication is not normal to the printer 40.

The flow chart of the operation of the authentication server 60 will be explained next. In step S51, the inquiry of the identification information is received from the printer 40. In step S52, the memory unit 63 is searched. In step S53, it is determined whether the identification information sent from the printer 40 matches to the identification information of the user, i.e., the user information, registered in the memory unit 63. When the identification information sent from the printer 40 matches to the user information, the process proceeds to step S54. When the identification information sent from the printer 40 does not match to the user information, the process proceeds to step S55.

In step S54, the authentication result indicating that the authentication is normal is returned to the printer 40, thereby completing the process. In step S55, the authentication result indicating that the authentication is not normal is returned to the printer 40, thereby completing the process.

As described above, in the third embodiment, it is determined whether the control command thus received is the command from the user who is authorized to use the printer 40, i.e., the authenticated command, or the command from the user who is not authorized to use the printer 40, i.e., the non-authenticated command, so that only the authenticated command is processed. Accordingly, it is possible to prevent the operation of the information processing apparatus based on an improper command, thereby preventing leak of information.

Further, the authentication server 60 exclusively controls the identification information of the user, i.e., the user information. Accordingly, it is possible to prevent a case in which the identification information is registered for a malicious user pretending to be a user who is authorized to use the printer 40. Further, when the user information to be controlled is changed, it is possible to quickly and easily cope with the change.

### Fourth Embodiment

A fourth embodiment will be explained next with reference to the accompanying drawings. Components in the fourth embodiment having configurations similar to those in the first to third embodiments are designated with the same reference numerals, and explanations thereof are omitted. Explanation of operations and effects in the fourth embodiment same as those in the first to third embodiments are omitted as well.

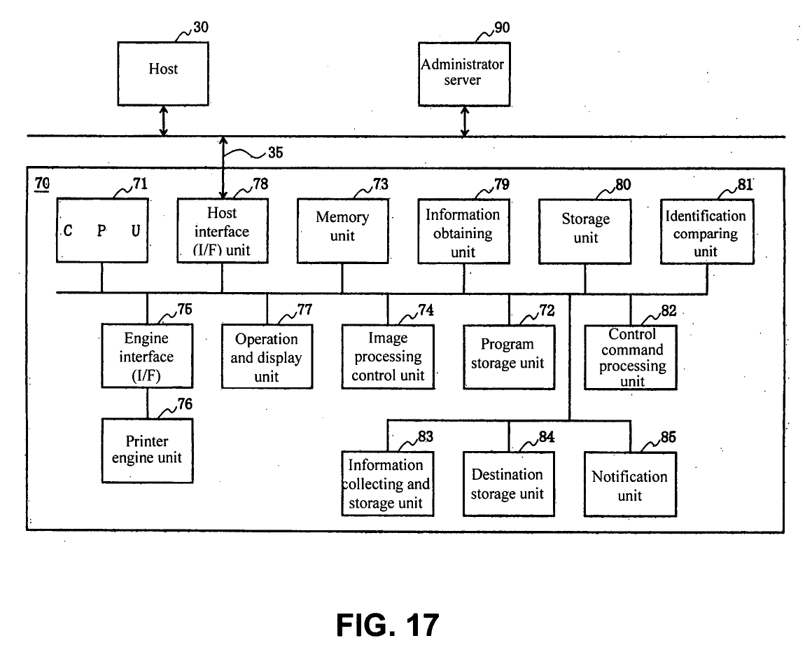

FIG. 17 is a block diagram showing a configuration of a printer 70, i.e., a printing apparatus as an information processing apparatus, according to the fourth embodiment of the present invention. The printer 70 may include an ink-jet printer, an electro-photography printer, a copier, a facsimile device, an image reading, a multi-function device having functions of a printer, a copier, a facsimile, and any other devices. Further, the printer 70 may be a device forming a monochrome image or a color image. In the embodiment, the printer 70 is an electro-photography printer.

As shown in FIG. 17, the printer 70 includes a CPU 71 for controlling the apparatus as a whole; a program storage unit 72; a memory unit 73; an image processing control unit 74; an engine interface (I/F) 75; a printer engine unit 76; an operation and display unit 77; a host interface (I/F) unit 78 as a receiving unit; an information obtaining unit 79 as an identification information obtaining unit; a storage unit 80; an identification comparing unit 81 as an identification information comparing unit; a control command processing unit 82; an information collecting and storage unit 83 as an information collection unit for collecting information related to a non-authenticated command; a destination storage unit 84 for storing destinations to which the information related to a non-authenticated command stored in the information collecting and storage unit 83 is sent; an notification unit 85 for notifying the information related to a non-authenticated command stored in the information collecting and storage unit 83 to a destination stored in the destination storage unit 84. The printer 70 is connected to the host 30 as an upper device and an administrator server 90 to which the information related to a non-authenticated command is sent through the interface cable 35 as a communication line.

The CPU 71 is formed of a microprocessor and the likes. Through execution of a program (firmware) stored in the program storage unit 72, the CPU 71 controls operations of the printer 70 as a whole including execution of a control command (described later), troubleshooting, information collection, and the likes. The program storage unit 72 is formed of a non-volatile memory such as a ROM, a flash memory, and the likes, and stores the program for controlling the printer 70 as a whole. Note that is it possible to rewrite the program written in the program storage unit 72.

The memory unit 73 is formed of a RAM, a flash memory, a hard disk, and the likes. The memory unit 73 temporarily stores information and the likes necessary for executing the program, and stores various information, information collection results, print data, and the likes. The image processing control unit 74 performs a process of image information that the printer 70 receives from the host 30, for example, a process such as compression, extension, code conversion, encryption, decryption, and the likes.

The operation and display unit 77 performs input of information to the printer 70 and displays information representing an operational state of the printer 70. The operation and display unit 77 is formed of a keyboard, a push button, a touch button, and the likes. A display unit of the operation and display unit 77 is formed of a liquid crystal display, an LED display, and the likes.

The host I/F unit 78 performs a connection process relative to the host 30 and the administrator server 90. The host 30 and the administrator server 90 may be connected to the printer 70 through various connection methods including a USB (Universal Serial Bus) connection, a parallel connection, a network connection, and the likes. The information obtaining unit 79 performs a process of retrieving identification information from a control command sent from the host 30.

The storage unit 80 stores user identification information such as a user ID, a password, and the likes. The identification comparing unit 81 compares the identification information or first identification information retrieved from the control command by the information obtaining unit 79 with the user identification information (user information) or second identification information stored in the storage unit 80.

The control command processing unit 82 performs a process of discarding the control command received from the host 30 when the comparison result of the identification comparing unit 81 is not match. The information collecting and storage unit 83 collects and stores information such as a source of the control command when it is determined that the control command received from the host 30 is the non-authenticated command.

The destination storage unit 84 stores information related to the destinations to which information related to the non-authenticated command is sent. The notification unit 85 notifies the information related to the non-authenticated command collected at the information collecting and storage unit 83 and identification information of the printer 70 to the destination stored in the destination storage unit 84, i.e., the administrator server 90.

The host 30 performs a process of creating the image information and the control command. The administrator host 90 receives the information related to the non-authenticated command and the identification information of the printer 70 sent from the notification unit 85.

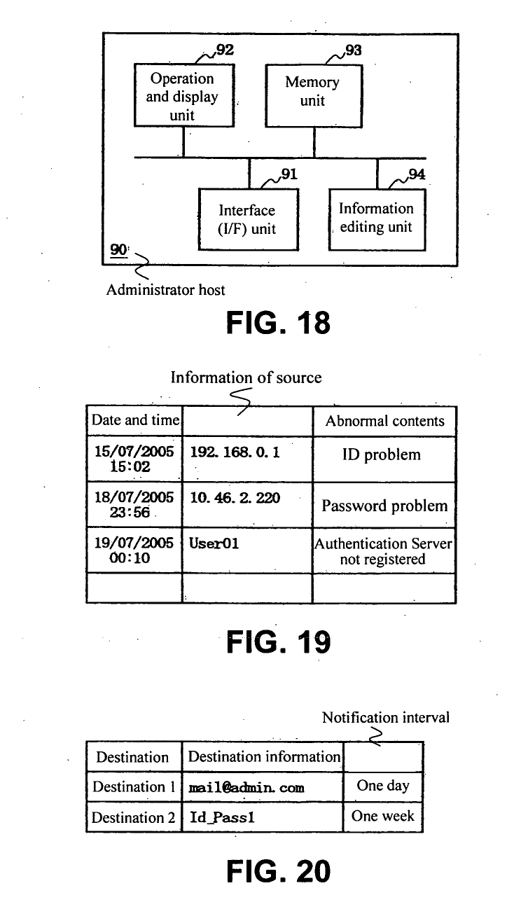

A configuration of the administrator server 90 will be explained next. FIG. 18 is a block diagram showing the configuration of the administrator host 90 according to the fourth embodiment of the present invention.

As shown in FIG. 18, the administrator host 90 includes an interface (I/F) unit 91 for performing communication with the printer 70 and the likes; an operation and display unit 92 for operating and displaying; a memory unit 93 for storing various information received form the printer 70; and an information editing unit 94 for editing the various information received from the printer 70.

The information stored in the information collecting and storage unit 83 will be explained next. FIG. 19 is a schematic view showing an example of the information stored in the information collecting and storage unit 83 according to the fourth embodiment of the present invention.

As shown in FIG. 19, the information collecting and storage unit 83 stores information such as date and time when the non-authenticated command is received; the information related to a source of the non-authenticated command (for example, an IP address, a network name, and the likes); and a reason for determining the non-authenticated command.

The information stored in the destination storage unit 84 will be explained next. FIG. 20 is a schematic view showing an example of the information stored in the destination storage unit 84 according to the fourth embodiment of the present invention. As shown in FIG. 20, the destination storage unit 84 stores information related to a number identifying a destination (for example, a destination 1 and the likes); destination information (for example, an e-mail address, a network name, and the likes); and a notification interval.

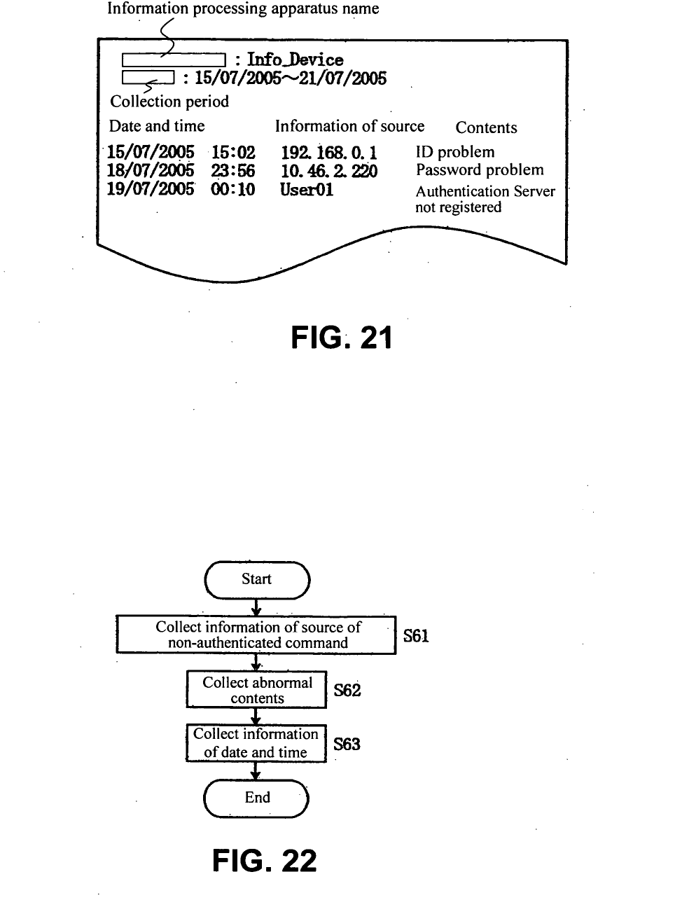

Notification contents that the notification unit 85 notifies to the destination will be explained next. FIG. 21 is a schematic view showing an example of the notification contents according to the fourth embodiment of the present invention. As shown in FIG. 21, the notification contents include a printer name; an information obtaining period; and the information related to the non-authenticated command collected at the information collecting and storage unit 83.

An operation of the printer 70 according to the fourth embodiment of the present invention will be explained next. First, an operation of collecting the information related to the non-authenticated command will be explained.

FIG. 22 is a flow chart of the operation of collecting the information according to the fourth embodiment of the present invention. In the fourth embodiment, the printer 70 is arranged to perform a process of collecting the information related to the non-authenticated command, in addition to the receiving and discarding process of the control command in the first to third embodiments.

First, the information collecting and storage unit 83 collects the information related to the source of the non-authenticated command. The header of the control command includes the information related to the source (for example, an IP address, a network name, and the likes). Accordingly, the information collecting and storage unit 83 collects the information related to the source from the header and stores the information.

Then, the information collecting and storage unit 83 collects and stores an abnormal reason, that is, the reason that the identification comparing unit 81 determines the control command to be the non-authenticated command (for example, an ID problem, a password problem, not registered in the authentication server 60, and the likes). Lastly, the information collecting and storage unit 83 collects and stores the information related to date and time when the non-authenticated command is received.

When the information collecting and storage unit 83 stores the information related to the non-authenticated command, if other information is already stored, the information collecting and storage unit 83 adds and stores the information related to the non-authenticated command at a last portion thereof.

The flow chart of the operation of collecting the information will be explained next. In step S61, the information related to the source of the non-authenticated command is collected. In step S62, abnormal contents are collected. In step S63, the information related to date and time is collected, thereby completing the process.

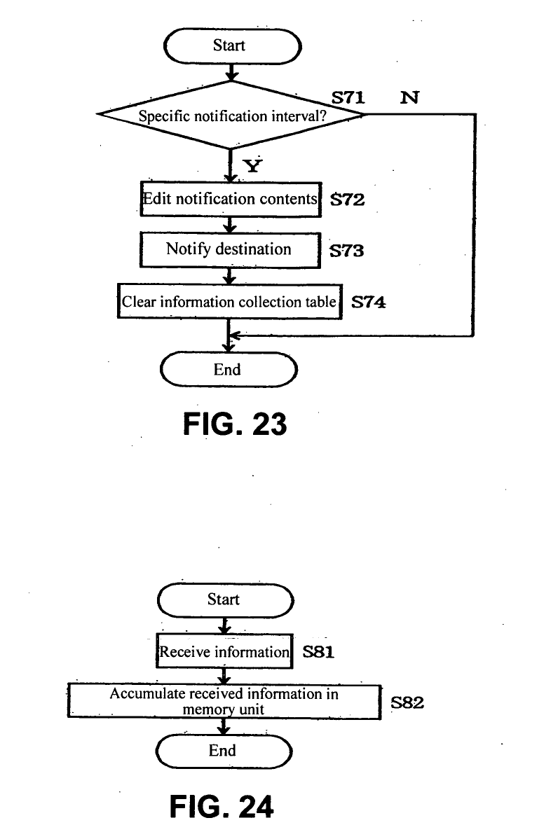

An operation will be explained next, in which the information related to the non-authenticated command stored in the information collecting and storage unit 83 is notified to the notification destination, for example, the administrator server 90 administrating the printer 70. FIG. 23 is a flow chart of the operation of notifying the information to the notification destination according to the fourth embodiment of the present invention.

The CPU 71 includes a timing unit (not shown) such as a counter. The CPU 71 determines whether a time measured with the counter reaches a specific notification interval (for example, one second) determined in advance. When it is determined that the time measured with the counter does not reach the notification interval, the counter is updated. When it is determined that the time measured with the counter reaches the notification interval, the notification contents including the information related to the non-authenticated command stored in the information collecting and storage unit 83 and the identification information of the printer 70 are edited to the format shown in FIG. 21.

Afterward, the notification unit 85 notifies the edited notification contents to the destination stored in the destination storage unit 84. The notification contents are notified through various methods including a method through an electric mail and a method through FTP (File Transfer Protocol). After the notification unit 85 notifies the destination, the CPU 71 clears an information collection table in the information collecting and storage unit 83, so that the collected information thus notified is deleted from the information collecting and storage unit 83.

The flow chart of the operation of notifying the information to the notification destination will be explained next. In step S71, it is determined whether it reaches the notification interval. When it reaches the notification interval, the process proceeds to step S72. When it does not reach the notification interval, the process is completed. In step S72, the notification contents are edited. In step S73, the destination is notified. In step S74, the information collection table is cleared, thereby completing the process.

An operation of the administrator host 90 will be explained next. FIG. 24 is a flow chart of the operation of the administrator host 90 according to the fourth embodiment of the present invention.

First, the administrator server 90 receives the information notified by the printer 70. Then, the administrator server 90 accumulates the information thus received in the memory unit 93. In this case, after the information editing unit 94 edits the information received from the printer 70 into a format capable of being stored in the memory unit 93, the information is accumulated in the memory unit 93.

The flow chart of the operation of the administrator host 90 will be explained next. In step S81, the information is received from the printer 70. In step S82, the information thus received is accumulated in the memory unit 93, thereby completing the process.

As described above, in the embodiment, when it is determined that the control command thus received is the command from a user who is not authorized to use the printer 70, i.e., the non-authenticated command, it is possible to notify the information related to the non-authenticated command to the specific notification destination.

In the first to fourth embodiments, the software (firmware) is executed to perform the various operations. The various operations may be performed with hardware. The information processing apparatus is the printer in the embodiments, and may be applicable to an MFP (Multi Function Printer), a scanner, or a personal computer.

The disclosure of Japanese Patent Application No. 2006-045588, filed on Feb. 22, 2006, is incorporated in the application.

While the invention has been explained with reference to the specific embodiments of the invention, the explanation is illustrative and the invention is limited only by the appended claims.

What is claimed is:

1. An information processing apparatus, comprising:
a receiving unit for receiving a control command including first identification information;
an identification information obtaining unit for obtaining the first identification information from the control command;
a storage unit for storing second identification information related to a specific user;
an identification information comparing unit for comparing the first identification information with the second identification information; and
a control command processing unit for performing a first process when the first identification information matches to the second identification information and performing a second process when the first identification information does not match to the second identification information.

2. The information processing apparatus according to claim 1, wherein said control command processing unit performs an execution process of the control command as the first process, and performs a receiving and discarding process of the control command as the second process.

3. The information processing apparatus according to claim 1, further comprising an information collecting unit for collecting information related to the control command, said control command processing unit performing a process of collecting the information related to the control command as the second process.

4. The information processing apparatus according to claim 3, further comprising a notification unit for externally notifying the information related to the control command stored in the information collecting unit at a specific interval.

5. The information processing apparatus according to claim 1, further comprising a decrypting unit for decrypting encrypted data, said decrypting unit decrypting the first identification information when the first identification information is encrypted.

6. An information processing apparatus to be connected to an authentication device that has second identification information related to a specific user and authenticates using the second identification information, comprising:
a receiving unit for receiving a control command including first identification information;
an authentication processing unit for sending the first identification information to the authentication device and receiving an authentication result of the first identification information; and
a control command processing unit for performing one of a first process and a second process according to the authentication result.

7. The information processing apparatus according to claim 6, wherein said control command processing unit performs the first process when the authentication result indicates that the first identification information matches to the second identification information, and performs the second process when the authentication result indicates that the first identification information does not match to the second identification information.

8. The information processing apparatus according to claim 6, wherein said control command processing unit performs an execution process of the control command as the first process, and performs a receiving and discarding process of the control command as the second process.

9. The information processing apparatus according to claim 6, further comprising an information collecting unit for collecting information related to the control command, said control command processing unit performing a process of collecting the information related to the control command as the second process.

10. The information processing apparatus according to claim 9, further comprising a notification unit for externally notifying the information related to the control command stored in the information collecting unit at a specific interval.

11. A printing apparatus, comprising:
a receiving unit for receiving a control command including first identification information;
an identification information obtaining unit for obtaining the first identification information from the control command;
a storage unit for storing second identification information related to a specific user;
an identification information comparing unit for comparing the first identification information with the second identification information; and
a control command processing unit for performing a first process when the first identification information matches to the second identification information and performing a second process when the first identification information does not match to the second identification information.

12. The printing apparatus according to claim 11, wherein said control command processing unit performs an execution process of the control command as the first process, and performs a receiving and discarding process of the control command as the second process.

13. The printing apparatus according to claim 11, further comprising an information collecting unit for collecting information related to the control command, said control command processing unit performing a process of collecting the information related to the control command as the second process.

14. The printing apparatus according to claim 13, further comprising a notification unit for externally notifying the information related to the control command stored in the information collecting unit at a specific interval.

15. The printing apparatus according to claim 11, further comprising a decrypting unit for decrypting encrypted data, said decrypting unit decrypting the first identification information when the first identification information is encrypted.

16. A printing apparatus to be connected to an authentication device that has second identification information related to a specific user and authenticates using the second identification information, comprising:
a receiving unit for receiving a control command including first identification information;
an authentication processing unit for sending the first identification information to the authentication device and receiving an authentication result of the first identification information; and
a control command processing unit for performing one of a first process and a second process according to the authentication result.

17. The printing apparatus according to claim 16, wherein said control command processing unit performs the first process when the authentication result indicates that the first identification information matches to the second identification information, and performs the second process when the authentication result indicates that the first identification information does not match to the second identification information.

18. The printing apparatus according to claim 16, wherein said control command processing unit performs an execution process of the control command as the first process, and performs a receiving and discarding process of the control command as the second process.

19. The printing apparatus according to claim 16, further comprising an information collecting unit for collecting information related to the control command, said control command processing unit performing a process of collecting the information related to the control command as the second process.

20. The printing apparatus according to claim 19, further comprising a notification unit for externally notifying the information related to the control command stored in the information collecting unit at a specific interval.
